(19) United States
(12) Patent Application Publication
(10) Pub. No.: US 2026/0045068 A1
(43) Pub. Date: Feb. 12, 2026

(54) SYSTEM(S) AND METHOD(S) FOR TRAINING A SIGN LANGUAGE NATURAL LANGUAGE PROCESSING MODEL AND SUBSEQUENT USE THEREOF

(71) Applicant: GOOGLE LLC, Mountain View, CA (US)

(72) Inventors: Garrett Tanzer, Boston, MA (US); Sepehr Sam Sepah, Pleasanton, CA (US)

(21) Appl. No.: 18/799,617

(22) Filed: Aug. 9, 2024

(51) Int. Cl. G06V 10/774; G06V 40/20

(52) U.S. Cl. CPC G06V 10/774; G06V 40/28

(57) ABSTRACT

Implementations are directed to training and subsequently utilizing a sign language natural language processing (NLP) model. Initially, processor(s) of a system can obtain sign language video content that captures two-handed sign language sign(s), generate augmented sign language video content that masks out at least a given hand, of two hands performing the two-handed sign language sign(s), and that results in one-handed sign language sign(s), training the sign language NLP model, and causing the sign language NLP model to be deployed (e.g., for utilization locally at client device(s) of user(s) and/or for utilization at a remote server). Subsequently, user(s) can direct one-handed sign language sign(s) to client device(s) that have access to the sign language NLP model to cause action(s) to be performed, such as at a mobile device while the user holding the mobile device while capturing the one-handed sign language sign(s) and/or in other situations.

### BACKGROUND

Humans' (also referred to herein as “users”) abilities to interact with other humans and/or to interact with machines (such as interactive software applications referred to herein as “automated assistants”) can sometimes be dependent upon whether they have any conditions that impact communication of information. For example, certain users may have completely diminished or partially diminished hearing, and/or may rely upon sign language or other inaudible communications techniques in their daily lives. As a result, these users' opportunities to interact with other humans may be limited by other users' understanding of sign language and/or to interact with machines may be limited to directly contacting a touch interface of a display. With respect to human interactions, this can be in part because of a lack of real-time translation capabilities of sign language for users who do not understand sign language. With respect to machine interactions, this can be in part because certain assistant-enabled devices may exclusively rely on a microphone to detect an invocation phrase or the like, rather than providing any other means for receiving an inaudible invocation command, and may also lack sign language natural language processing models at client devices. These problems are exacerbated when the user is interacting with certain client devices that have a limited field of view for capturing sign language sign(s), such as mobile client devices when a user may be required to hold the mobile client device with one hand to capture one-handed sign language sign(s) with the other hand or when one of the user's hands is occupied (e.g., while driving) or otherwise unavailable for providing two-handed sign language sign(s) (e.g., the user is missing a hand, the user is holding something with a hand, etc.).

### SUMMARY

Implementations described herein are directed to training and subsequently utilizing a sign language natural language processing (NLP) model. Initially, processor(s) of a system can obtain sign language video content that captures two-handed sign language sign(s), generate augmented sign language video content that masks out at least a given hand, of two hands performing the two-handed sign language sign(s), and that results in one-handed sign language sign(s), training the sign language NLP model based on the augmented sign language video content, and causing the sign language NLP model to be deployed (e.g., for utilization locally at client device(s) of user(s) and/or for utilization at a remote server). Subsequently, user(s) can direct one-handed sign language sign(s) to client device(s) that have access to the sign language NLP model to cause action(s) to be performed, such as at a mobile device while the user holding the mobile device while capturing the one-handed sign language sign(s) and/or in other situations.

For example, sign language NLP models have been developed that are capable of interpreting two-handed sign language signs based on processing training instances that include two-handed sign language signs as training instance input and ground truth natural language interpretations of the two-handed sign language signs as training instance output. However, these sign language NLP models generally fail or misinterpret signs if a user is only performing one-handed sign language. Accordingly, techniques described herein can initially obtain sign language video content that captures two-handed sign language signs, but augment the sign language video content such that it appears as if the two-handed sign language signs are one-handed sign language signs. This augment the sign language video content can be utilized as training instance input for subsequently training a sign language NLP model to interpret the one-handed sign language signs. Further, captions associated with the two-handed sign language signs can be utilized as training instance output. Thus, in processing the augmented sign language video content, predicted captions can be generated and compared to the captions associated with the two-handed sign language signs to generate loss(es) that are utilized to update the sign language NLP model. Notably, by training the sign language NLP model in these and other manners described herein, not only is the sign language NLP model trained to interpret one-handed sign language signs, but it is also capable of interpreting two-handed sign language signs.

In some implementations, and in generating the augmented sign language video content, the system can detect a dominant hand of the user performing the two-handed sign language sign(s), and the given hand that is masked out to generate the augmented sign language video content can be a non-dominant hand of the user performing the two-handed sign language sign(s). For example, the system can process, using a classifier (e.g., that is trained on labeled data) or heuristic process (e.g., that instructs the system to determine which hand moves more when the two-handed sign language sign(s) are being performed), the sign language video content to determine the dominant hand of the user (i.e., which is more active while the user performs the two-handed sign language sign(s)).

In additional or alternative implementations, and in generating the augmented sign language video content, the system can detect a right hand of the user performing the two-handed sign language sign(s), and the given hand that is masked out to generate the augmented sign language video content can be a left hand of the user performing the two-handed sign language sign(s). For example, the system can process, using the aforementioned classifier or heuristic process, the sign language video content to determine the right hand of the user (i.e., since a vast majority of users are right-handed).

In implementations where the non-dominant hand and/or the left hand are masked to generate the augmented sign language video content, the system can mask the non-dominant hand and/or the left hand by modifying modify pixel values of a portion of the sign language video content that includes the non-dominant hand and/or the left hand, placing a bounding box around a portion of the sign language video content that includes the non-dominant hand and/or the left hand, cropping out a portion of the sign language video content that includes the non-dominant hand and/or the left hand, adjust a frame of the sign language video content to only include the dominant hand and/or the right hand, and/or perform other operations to generate the augmented sign language video content. Although the above examples are described with respect to only masking the non-dominant hand and/or the left hand it should be understood that is for the sake of example and is not meant to be limiting. For instance, it should be understood that other features or body parts of the user can additionally be masked, such as the user's elbows, above the neck/head, below the waist, etc.

In additional or alternative implementations, and in generating the augmented sign language video content, the system can process, using a generative model, the sign language video content to directly generate the augmented sign language video content. The generative model can be trained, fine-tuned, or instruction-tuned to generate the augmented sign language video content. For example, the system can train or fine-tune the generative model based on a plurality of training instance pairs that include one or more two-handed sign language signs and one or more corresponding one-handed sign language signs. In training or fine-tuning the generative model, the system can process, using the generative model, the one or more two-handed sign language signs to generate one or more corresponding predicted one-handed sign language signs. Further, and based on comparing the one or more corresponding predicted one-handed sign language signs and the one or more corresponding one-handed sign language signs, the system can generate one or more losses for the generative model. The system can then utilize the one or more losses to update the generative model. As another example, the generative model can be instruction-tuned using zero-shot examples that include the training instance pairs.

In various implementations, the sign language video content and/or the augmented sign language video content can be mirrored such that it appears as if the non-dominant hand of the user and/or the left hand of the user is performing the sign language sign(s). For example, prior to masking the sign language video content to generate the augmented sign language video content, the sign language video content can be mirrored along a y-axis, a landmark of the user's hand(s), and/or based on other features captured in the sign language video content. In this example, the sign language video content can then be masked to generate the augmented sign language video content. As another example, subsequent to generating the augmented sign language video content, the augmented sign language video content can be mirrored along a y-axis, a landmark of the user's hand(s), and/or based on other features captured in the augmented sign language video content. As yet another example, the generative model can be trained, fine-tuned, or instruction-tuned to generate some instances of the sign language video content in a mirrored fashion.

Notably, in these implementations, and in training the sign language NLP model, the sign language NLP model can additionally process an indication of whether the sign language video content and/or the augmented sign language video content was mirrored. The indication of whether the sign language video content and/or the augmented sign language video content was mirrored can be, for example, a binary value of “0” or “1” indicating mirroring or no mirroring, a natural language explanation indicating mirroring or no mirroring, a token indicating mirroring no mirroring, etc. In these implementations, and by causing the sign language NLP model to additionally process an indication of whether the sign language video content and/or the augmented sign language video content was mirrored, the sign language NLP model can be adequately conditioned to predict the correct output when, for example, an interpretation of any of the sign language signs captured in the augmented sign language video content are dependent on a direction (e.g., the user pointing in a particular direction to sign left or right).

In some versions of those implementations, the system can determine to mirror the sign language video content and/or the augmented sign language video content according to a probability or probability distribution. For example, the system can determine to mirror every other instance of the sign language video content and/or the augmented sign language video content that is processed, one of every four instances of the sign language video content and/or the augmented sign language video content that is processed, etc. In additional or alternative versions of those implementations, the system can determine to mirror every instance of the sign language video content and/or the augmented sign language video content that is processed, such that each instance of the sign language video content and/or the augmented sign language video content that is processed results in two disparate training instances—one that includes augmented sign language video content that is not mirrored and one that includes augmented sign language video content that is mirrored.

In some implementations, and in training the sign language NLP model, the system can process, using the sign language NLP model, the augmented sign language video content (and optionally an indication of whether the sign language video content was mirrored) to generate predicted output. Further, the system can determine, based on the predicted output, a predicted natural language interpretation of the one-handed sign language sign(s) captured in the augmented sign language video content. In some instances, the predicted output can be the predicted natural language interpretation of the one-handed sign language sign(s) whereas, in other instances, the predicted output can be a probability distribution over a sequence of tokens (e.g., words or word units) based on which the predicted natural language interpretation of the one-handed sign language sign(s) can be determined. Moreover, the system can compare the predicted natural language interpretation of the one-handed sign language sign(s) to a ground truth natural language interpretation of the one-handed sign language sign(s) to generate one or more losses (e.g., based on word error therebetween, an edit distance therebetween, etc.). Furthermore, the sign language NLP model can be updated based on the one or more losses.

In some implementations, and in causing the sign language NLP model to be deployed, the sign language NLP model can be utilized in an online manner (e.g., in response to vision data being captured at a client device that includes a user performing one-handed sign language). In some versions of those implementations, the sign language NLP model can be executed locally at a client device such that the client device processes the vision data to determine action(s) to be performed by the client device and/or an automated assistant executing at least in part at the client device. For example, the user can hold a mobile device (e.g., phone) using one hand and direct a field of view of the vision component(s) towards their other hand and perform the one-handed sign language sign(s) with the other hand. As another example, the user can be engaged in video call with an additional user via respective client devices and the client device of the user that is receiving vision data of the user performing the one-handed sign language sign(s) can be utilized to translate the one-handed sign language sign(s). As yet another example, the user can cook using one hand and sign with their other hand towards a standalone speaker device having vision component(s) to set a timer, reminder, etc. In some additional or alternative versions of those implementations, the sign language NLP model can be executed remotely from a client device such that the client device transmits the vision data (or a portion thereof) to a remote system (e.g., a remote server) and receives an indication of action(s) to be performed from the remote system or a translation of the one-handed sign language sign(s). In additional or alternative implementations, and in causing the sign language NLP model to be deployed, the sign language NLP model can be utilized in an online manner (e.g., in response to detecting content that includes a user performing one-handed sign language, but is not performed by a user of the client device or streamed to the client device of the user or an additional user).

By using techniques described herein, one or more technical advantages can be achieved. As one non-limiting example, by generating the augmented sign language video content as described herein to train the sign language NLP model, the sign language NLP model can be effectively deployed at client devices that traditionally have not been able to execute sign language NLP models (e.g., due to limited fields of view), thereby extending input modalities to certain populations of users to interact with these client devices. As a result, the certain populations of users can more efficiently interact with these client devices since a quantity of inputs received at the client devices can be reduced in many cases, thereby conserving computational resources. As another non-limiting example, by causing the sign language NLP model to additionally process the indication of whether the sign language video content and/or the augmented sign language video content was mirrored, the sign language NLP model can be adequately conditioned to predict the correct output when, for example, an interpretation of any of the sign language signs captured in the augmented sign language video content are dependent on a direction (e.g., the user pointing in a particular direction to sign left or right). As a result, occurrences of incorrect interpretations of one-handed sign language sign(s) can be mitigated and/or eliminated which, in turn, can reduce a quantity of resources consumed since occurrences of follow-up interactions to correct the incorrect interpretations of one-handed sign language sign(s) are also mitigated and/or eliminated.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which implementations disclosed herein can be implemented.

FIG. 2 depicts an example process flow using various components from the example environment from FIG. 1, in accordance with various implementations.

FIG. 3 depicts a flowchart illustrating an example method of generating training instances for training a sign language natural language processing model and training the sign language natural language processing model, in accordance with various implementations.

FIG. 4 depicts a flowchart illustrating an example method of using a sign language natural language processing model, in accordance with various implementations.

FIGS. 5A, 5B, and 5C depict various non-limiting examples of obtaining sign language video content and generating, based on the sign language video content, augmented sign language video content, in accordance with various implementations.

FIG. 6 depicts a non-limiting example of utilizing a trained sign language natural language processing model, in accordance with various implementations.

FIG. 7 depicts an example architecture of a computing device, in accordance with various implementations.

### DETAILED DESCRIPTION

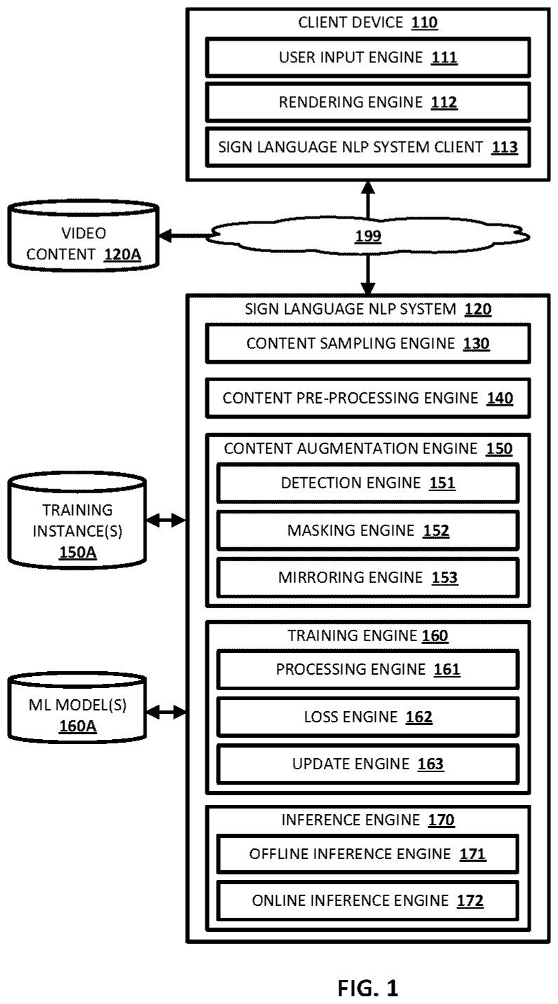

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a sign language natural language processing (NLP) system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, a transcript of a conversation between a user of the client device 110 and an automated assistant executing at least in part at the client device 110, a transcript of a conversation between the automated assistant executing at least in part at the client device 110 and an additional user that is in addition to the user of the client device 110, a transcript of a conversation between a user of the client device 110 and an additional user that is in addition to the user of the client device 110, notifications, selectable graphical elements, and/or any other content and/or output described herein.

Further, the client device 110 is illustrated in FIG. 1 as communicatively coupled, over one or more networks 199 (e.g., any combination of Wi-Fi®, Bluetooth®, or other local area networks (LANs); ethernet, the Internet, or other wide area networks (WANs); and/or other networks), to a sign language NLP system 120 implemented remotely from the client device 110. The sign language NLP system 120 can be implemented by, for example, a high-performance server, a cluster of high-performance servers, and/or any other computing device that is remote from the client device 110. The sign language NLP system 120 includes, in various implementations, a content sampling engine 130, a content pre-processing engine 140, a content augmentation engine 150, a training engine 160, and an inference engine 170. The content augmentation engine 150 can include various sub-engines, such as a detection engine 151, a masking engine 152, and a mirroring engine 153. Further, the training engine 160 can include various sub-engines, such as a processing engine 161, a loss engine 162, and an update engine 163. Moreover, the inference engine 170 can include various sub-engines, such as an offline inference engine 171 and an online inference engine 172.

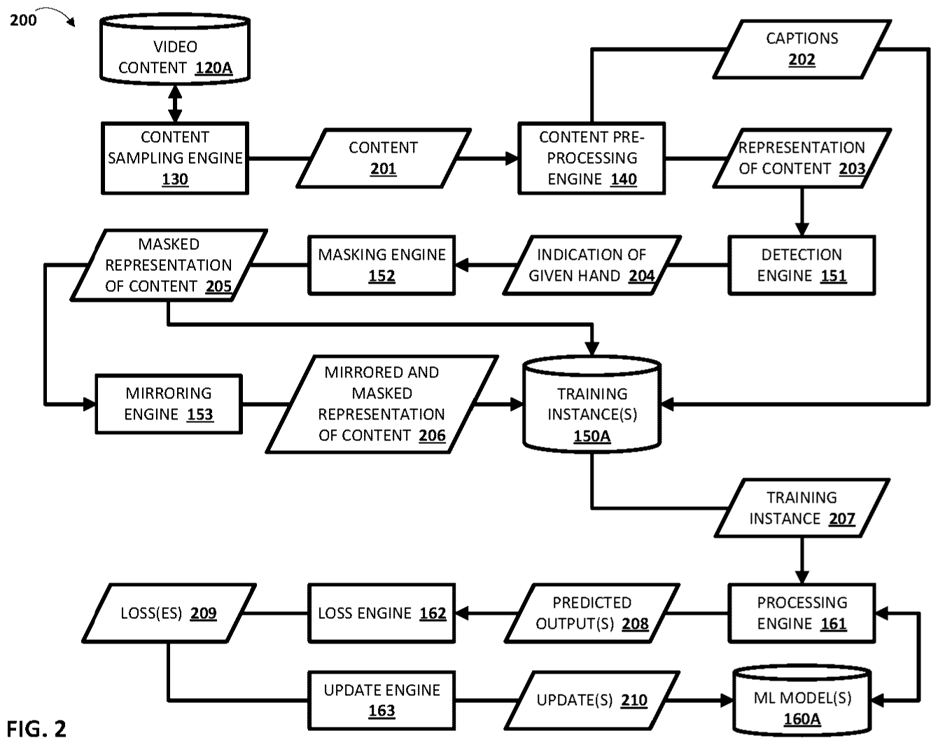

The sign language NLP system 120 can interact with various databases. For instance, and as described with respect to FIG. 2, the content sampling engine 130 can leverage video content 120A database to obtain sign language video content that is utilized in generating a plurality of training instances for training a sign language NLP model; the content augmentation engine 150A can generate the plurality of training instances based on the sign language video content that is obtained from the video content database 120A and store the plurality of training instances for training the sign language NLP model in training instance(s) database 150A; and the training engine 160 can access machine learning (ML) model(s) database 160A to obtain the sign language NLP model for training thereof and utilizing the plurality of training instances stored in the training instance(s) database 150A. Although FIG. 1 is depicted with respect to certain databases, it should be understood that is for the sake of example and is not meant to be limiting.

Moreover, the client device 110 can execute the sign language NLP system client 113. An instance of the sign language NLP system client 113 can be an application that is separate from an operating system of the client device 110 (e.g., installed “on top” of the operating system)—or can alternatively be implemented directly by the operating system of the client device 110. The sign language NLP system client 113 can communicate with the sign language NLP system 120 via one or more of the networks 199 (e.g., as shown in FIG. 1). It should be understood that the sign language NLP system client 113 can implement the sign language NLP system 120 locally at the client device 110. However, it should also be understood that one or more aspects of the sign language NLP system 120 can be implemented remotely from the client device 110 (e.g., exclusively at sign language NLP system 120), or at both remotely the sign language NLP system 120 and locally the client device 110 in a distributed manner.

Furthermore, the client device 110 and/or the sign language NLP system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the sign language NLP system 120 (e.g., over the one or more networks 199). As another example, a given client device can be utilized by multiple users in a shared setting (e.g., a group of users, a household, etc.).

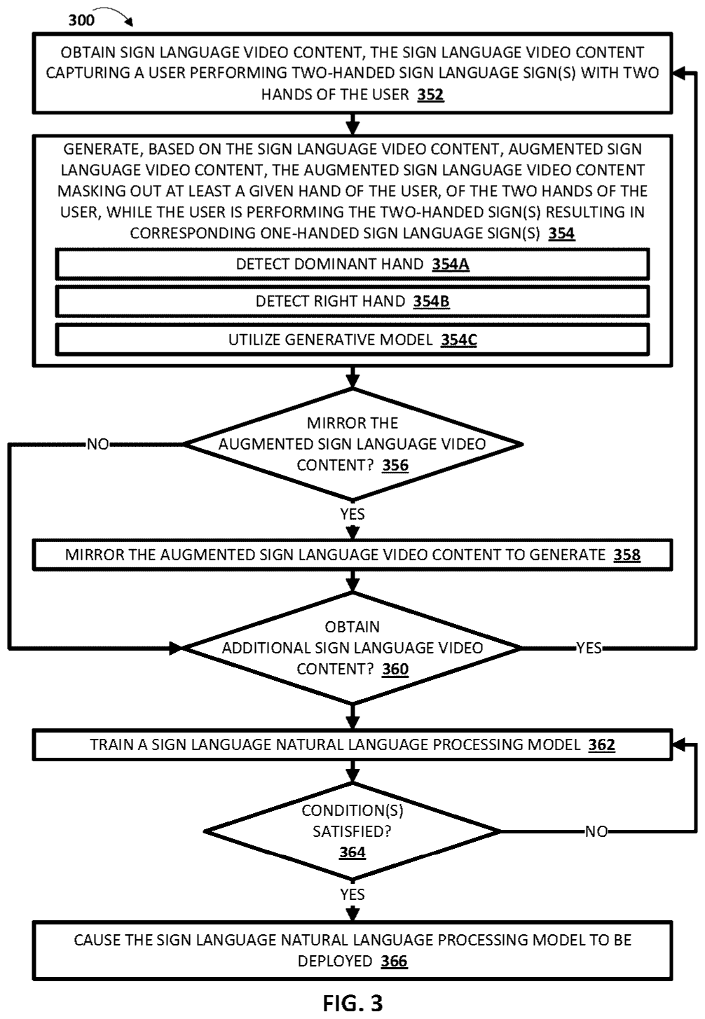

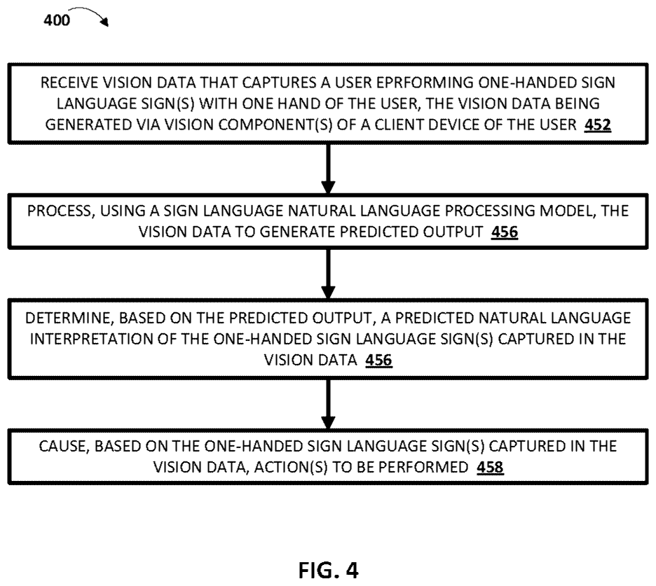

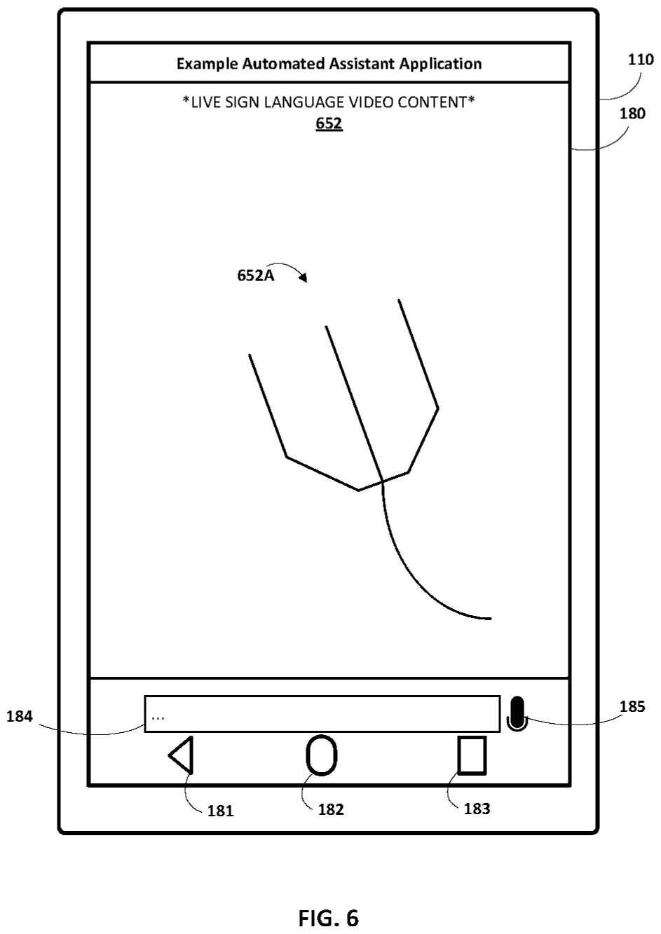

As described herein, the sign language NLP system 120 can be utilized to train a sign language NLP model and/or utilized in subsequent utilization of the trained sign language NLP model. The sign language NLP model described herein can be, for example, an encoder-decoder Transformer ML model, an encoder-only Transformer ML model, a decoder-only Transformer ML model, or any sequence-to-sequence based ML model that optionally includes an attention mechanism or other memory. Prior to training the sign language NLP model, the sign language NLP system 120 can generate a plurality of training instances (e.g., as described with respect to FIGS. 2, 3, and 5A-5C). This enables the sign language NLP system 120 to train the sign language NLP model, based on the plurality of training instances (e.g., as described with respect to FIGS. 2 and 3), to understand one-handed sign language sign(s) and/or two-handed sign language sign(s). Subsequently, the sign language NLP system 120 can cause the trained sign language NLP model to be utilized in an offline manner and/or in an online manner (e.g., as described with respect to FIGS. 4 and 6). Additional description of the content sampling engine 130, the content pre-processing engine 140, the content augmentation engine 150, the training engine 160, and the inference engine 170 is provided herein (e.g., with respect to FIGS. 2, 3, 4, 5A, 5B, 5C, and 6).

Referring now to FIG. 2, an example process flow 200 utilizing various components from the example environment of FIG. 1 is depicted. For the sake of example, assume that the content sampling engine 130 samples content 201 from one or more databases (e.g., the video content database 120A). The content 201 may include at least sign language video content (e.g., vision data that captures a human performing one or more two-handed sign language signs with two hands). Further, the content pre-processing engine 140 can obtain captions 202 for the content 201 and optionally process the content 201 to generate a representation of content 203.

In some implementations, the sign language video content captured in the content 201 may be stored in associated with a caption track that includes a ground truth natural language interpretation of the one or more two-handed sign language signs. In these implementations, the content pre-processing engine 140 can obtain the caption track (e.g., including the ground truth natural language interpretation of the one or more two-handed sign language signs) as the captions 202. In additional or alternative implementations, the sign language video content captured in the content 201 can be processed using, for example, a previously trained sign language NLP model that was previously trained to translate two-handed sign language signs to generate the ground truth natural language interpretation of the one or more two-handed sign language signs. In these implementations, the content pre-processing engine 140 can cause the sign language video content to be processed, using the previously trained sign language NLP model, to obtain the caption track (e.g., including the ground truth natural language interpretation of the one or more two-handed sign language signs) as the captions 202. The captions 202 can be stored in the training instance(s) database 150A and for subsequent utilization in training a sign language NLP model that is capable of translating one-handed sign language.

In some implementations, the sign language video content captured in the content 201 can include a sequence of image frames, raw pixel values for the sequence of image frames, etc. In some versions of these implementations, the representation of content 203 can be the sequence of the image frames, the raw pixel values for the sequence of the image frames, etc. However, in other versions of those implementations, the representation of content 203 can be some lower-dimensional representation of the sequence of the image frames, the raw pixel values for the sequence of the image frames, etc. For example, the content pre-processing engine 140 can cause the sign language video content to be processed, using MediaPipe Holistic or another computer vision tool, to generate a skeletonized representation of the one or more two-handed sign language signs as they are being performed. The skeletonized representation of the one or more two-handed sign language signs includes landmarks for the human body (e.g., fingers, joints, arms, elbows, shoulders, eyebrows, etc.) as the one or more two-handed sign language signs as they are being performed. In additional or alternative implementations, the sign language video content captured in the content 201 can include the skeletonized representation of the one or more two-handed sign language signs. In some versions of these implementations, the representation of content 203 can be the skeletonized representation of the one or more two-handed sign language signs and without performing any additional processing (e.g., using MediaPipe Holistic or another computer vision tool).

Further, the detection engine 151 can process the representation of content 203 to determine an indication of a given hand 204, of the two hands of the user performing the one or more two-handed sign language signs, that is to be masked to generate augmented sign language video content. In some implementations, the detection engine 151 can process, using a classifier (e.g., that is trained on labeled data) or a heuristic process (e.g., that instructs the detection engine 151 to determine which hand moves more when the one or more two-handed sign language signs are being performed), the representation of content 203 to determine a dominant hand of the user (i.e., which is more active while the user performs the one or more two-handed sign language signs). In these implementations, the detection engine 151 can provide an indication of the dominant hand and/or non-dominant hand as the indication of the given hand 204. This enables the masking engine 152 to mask out at least the non-dominant hand of the user (and optionally other features of the user, such elbows, shoulders, facial features, etc.), thereby resulting in a masked representation of content 205. Put another way, the content 201 that is originally obtained by the content sampling engine 130 may include the user performing the one or more two-handed sign language signs, but the masked representation of content 205 only includes the user performing the same one or more two-handed sign language signs, but as if the user was only performing these signs with one hand. The masking engine 152 can cause the masked representation of content 205 to be stored in the training instance(s) database 150A and in association with the captions 202 for the content 201.

In additional or alternative implementations, the detection engine 151 can process, using a classifier (e.g., that is trained on labeled data) or a heuristic process (e.g., that instructs the detection engine 151 to determine which hand moves more when the one or more two-handed sign language signs are being performed), the representation of content 203 to determine a right hand of the user. In these implementations, the detection engine 151 can provide an indication of the right hand and/or left hand as the indication of the given hand 204. This enables the masking engine 152 to mask out at least the left hand of the user (and optionally other features of the user, such elbows, shoulders, facial features, etc.) since a vast majority of users are right-handed, thereby resulting in a masked representation of content 205. Put another way, the content 201 that is originally obtained by the content sampling engine 130 may include the user performing the one or more two-handed sign language signs, but the masked representation of content 205 only includes the user performing the same one or more two-handed sign language signs, but as if the user was only performing these signs with their right hand. The masking engine 152 can cause the masked representation of content 205 to be stored in the training instance(s) database 150A and in association with the captions 202 for the content 201.

In additional or alternative implementations, the detection engine 151 can process, using a trained or fine-tuned generative model (e.g., Gemini, Bard, ChatGPT, etc.), the representation of content 203 to directly generate the masked representation of content 205. For example, the trained generative model can be trained or fine-tuned based on a plurality of training instance pairs that include one or more two-handed sign language signs and one or more corresponding one-handed sign language signs. In training or fine-tuning the generative model, the generative model can process the one or more two-handed sign language signs to generate one or more corresponding predicted one-handed sign language signs. Further, and based on comparing the one or more corresponding predicted one-handed sign language signs and the one or more corresponding one-handed sign language signs, one or more losses can be generated. The one or more losses can be utilized to update the generative model. Accordingly, this training or fine-tuning enables the generative model to directly generate the masked representation of content 205 based on processing the representation of content 203. The masking engine 152 can cause the masked representation of content 205 to be stored in the training instance(s) database 150A and in association with the captions 202 for the content 201.

In implementations that utilize the classifier or heuristic process to determine the indication of the given hand 204, and in masking the representation of content 203 to generate the masked representation of content 205, the masking engine 152 can modify pixel values of a portion of the representation of content 203 that is to be masked, place bounding boxes around a portion of the representation of content 203 that is to be masked, crop a portion of the representation of content 203 that is to be masked, adjust a frame of the representation of content 203 that is to be masked (e.g., zoom in on a portion of the representation of content 203 that is not to be masked), and/or perform other operations to generate the masked representation of content 205. In implementations that utilize the generative model to generate the masked representation of content 205 (e.g., and without explicitly determining the indication of the given hand 204), the generative model can be trained or fine-tuned to mask the representation of content 203 in the same or similar manner described above. Additionally, or alternatively, the generative model can be instruction-tuned to mask the representation of content 203 in the same or similar manner described above (e.g., an explicit prompt or set instructions included along with the representation of content 203 to mask it in one or more of the particular manners described above), thereby generating the masked representation of content 205.

Notably, in implementations where the representation of content 203 is the sequence of the image frames, the raw pixel values for the sequence of the image frames, etc., the masked representation of content 205 can correspond to a masked version of the sequence of the image frames, the raw pixel values for the sequence of the image frames, etc. Further, in implementations where the representation of content 203 is some lower-dimensional representation of the sequence of the image frames, the raw pixel values for the sequence of the image frames, etc., the masked representation of content 205 can correspond to a reduced size version of the lower-dimensional representation of the sequence of the image frames, the raw pixel values for the sequence of the image frames, etc.

In some implementations, the mirroring engine 151 can process the representation of content 203 or the masked representation of content 205 to generate a mirrored and masked representation of content 206. Accordingly, in some versions of these implementations, multiple training instances can be generated based on the content 201 that is obtained. For example, assume the left hand of the user is masked is the masked representation of content 205. In this example, a first training instance can include vision data or a lower-dimensional representation of the right hand of the user performing the one or more sign language signs and the captions 202 for the one or more sign language signs. Further assume that the representation of content 203 or the masked representation of content 205 is mirrored. In this example, a second training instance can include vision data or a lower-dimensional representation of a mirrored version of the right hand of the user performing the one or more sign language signs (e.g., such that it appears the one or more sign language signs are being performed by the left hand of the user) and the captions 202 for the one or more sign language signs. Notably, in other versions of these implementations, only one training instance may be generated based on the content 201 that is obtained (e.g., based on one of the masked representation of content 205 or the mirrored and masked representation of content 206).

In implementations where the representation of content 203 or the masked representation of content 205 is the sequence of the image frames, the raw pixel values for the sequence of the image frames, etc., the pixels can be flipped, for example, with respect to a vertical y-axis. In some versions of these implementations, and prior to causing the mirrored and masked representation of content 206 to be stored in the training instance(s) database 150A and in association with the captions 202 for the content 201, the content pre-processing engine can process the mirrored and masked representation of content 206 to generate the lower-dimensional version of the sequence of the image frames, the raw pixel values for the sequence of the image frames, etc. captured in the mirrored and masked representation of content 206. By utilizing the lower-dimensional version of the sequence of the image frames, the raw pixel values for the sequence of the image frames, etc. in lieu of the sequence of the image frames, the raw pixel values for the sequence of the image frames, etc., computational resources can be conserved in subsequently training the sign language NLP model since a relatively smaller quantity of data is processed. In these implementations, an indication that the representation of content 203 or the masked representation of content 205 was mirrored can also be stored in the training instance(s) database 150A and in associated with the mirrored and masked representation of content 206 and in association with the captions 202 for the content 201.

In implementations where the representation of content 203 or the masked representation of content 205 is the lower-dimensional representation of the sequence of the image frames, the raw pixel values for the sequence of the image frames, etc., the lower-dimensional representation of the sequence of the image frames, the raw pixel values for the sequence of the image frames, etc. can be manipulated to effectively flip the lower-dimensional representation, for example, with respect to a vertical y-axis. For example, the lower-dimensional representation can be mirrored around a landmark corresponding to a thumb of the unmasked hand or some other landmark that is captured in the lower-dimensional representation. In these implementations, an indication that the representation of content 203 or the masked representation of content 205 was mirrored can also be stored in the training instance(s) database 150A and in associated with the mirrored and masked representation of content 206 and in association with the captions 202 for the content 201.

In implementations where the generative model is utilized to process the representation of content 203, the generative model can optionally be utilized to, additionally or alternatively, directly generate the mirrored and masked representation of content 206. For example, the generative model can be trained or fine-tuned to not only mask the representation of content 203 to generate the masked representation of content 205, but can also be trained or fine-tuned to further mirror the representation of content 203, thereby generating the mirrored and masked representation of content 206. Additionally, or alternatively, the generative model can be instruction-tuned to mask and mirror the representation of content 203 (e.g., an explicit prompt or set instructions included along with the representation of content 203 to not only mask it, but to also mirror it). In these implementations, an indication that the representation of content 203 or the masked representation of content 205 was mirrored can also be stored in the training instance(s) database 150A and in associated with the mirrored and masked representation of content 206 and in association with the captions 202 for the content 201.

In various implementations, and in mirroring the representation of content 203 or the masked representation of content 205, the sign language NLP system 120 can determine whether to cause the representation of content 203 or the masked representation of content 205 to be mirrored according to a probability or probability distribution. For example, and for each instance of the content 201 that is sampled, there may be a probability of 0.25, 0.5, 0.75, or the like that the representation of content 203 or the masked representation of content 205 will be mirrored. Accordingly, by considering the probability in determining whether to mirror the representation of content 203 or the masked representation of content 205, the training instance(s) stored in the training instance(s) database 150A will have sufficient diversity to recognize sign language signs performed using only a right hand of a user or sign language signs performed using only a left hand of a user even though the video content database 120A may include no/little video content of signers that are left-handed. This aforementioned portion of the process flow 200 may be repeated based on additional content sampled from the video content database 120A to generate additional training instances.

Subsequent to storing training instances in the training instance(s) database 150A, the sign language NLP system 120 can train the sign language NLP model. The processing engine 161 can obtain a given training instance 207. The given training instance 207 can include, for example, training instance input including the masked representation of content 205 or the mirrored and masked representation of content 206 and, optionally, an indication of whether the masked representation of content 205 is not mirrored (e.g., a binary value of “0” or “1” indicating no mirroring, a natural language explanation indicating no mirroring, a token indicating no mirroring, etc.) or whether the mirrored and masked representation of content 206 is mirrored (e.g., another binary value of “0” or “1” indicating mirroring, a natural language explanation indicating mirroring, a token indicating mirroring, etc.). The given training instance 207 can further include, for example, training instance output including the captions 202 as a ground truth natural language interpretation of the sign language signs captured in the masked representation of content 205 or the mirrored and masked representation of content 206 of the training instance input for the given training instance 207.

Further, the processing engine 161 can process, using the sign language NLP model (e.g., stored in the ML model(s) database 160A), the training instance input to generate predicted output(s) 208. In some implementations, the predicted output(s) 208 can include a predicted natural language interpretation of the sign language signs captured in the masked representation of content 205 or the mirrored and masked representation of content 206 of the training instance input for the given training instance 207. In other implementations, the predicted output(s) 208 can include a probability distribution over a sequence of tokens (e.g., words, word chunks, etc.). In these implementations, the processing engine 161 can further determine, based on the probability distribution over the sequence of tokens, the predicted natural language interpretation of the sign language signs captured in the masked representation of content 205 or the mirrored and masked representation of content 206 of the training instance input for the given training instance 207. In implementations where the training instance input of the given training instance 207 includes the indication of whether the content is mirrored or not, this indication can be utilized to condition to sign language NLP model to the extent that some aspects of sign language are dependent on absolute direction (e.g., pointing left, pointing right, etc.). By including the indication, the sign language NLP model can effectively learn, for example, that if a user pointing left in mirrored content, then that should actually be interpreted as the user pointing right since the content was mirrored.

Moreover, the loss engine 162 can generate one or more losses 209 based on comparing the predicted natural language interpretation of the sign language signs captured in the masked representation of content 205 or the mirrored and masked representation of content 206 of the training instance input for the given training instance 207 and the ground truth natural language interpretation of the sign language signs captured in the masked representation of content 205 or the mirrored and masked representation of content 206 of the training instance input for the given training instance 207. For example, the one or more losses 209 can be based on an error rate, edit distance, and/or other factors determined based on the comparison. This enables the update engine 163 to generate, based on the one or more losses, update(s) 210 for the sign language NLP model, and the update engine 163 to update, based on the update(s) 210, the sign language NLP model (e.g., via backpropagation of the loss(es) 209 or using another suitable technique).

Subsequent to training the sign language NLP model, the sign language NLP system 120 can cause the sign language NLP model to be deployed for utilization locally at client devices and/or at remote system(s). As one non-limiting example, the sign language NLP model can be utilized by the offline inference engine 171 in an offline manner, such as by processing one-handed sign language video content that is uploaded to a video repository to determine natural language interpretations of the one-handed sign language video content. As another non-limiting example, the sign language NLP model can be utilized by the online inference engine 172 in an online manner, such as by enabling a user to interact with an automated assistant via one-handed sign language, dictate text via one-handed sign language, and/or in other manners. Although the sign language NLP model is described with respect to being trained to process one-handed sign language video content, it should be understood that is for the sake of example and is not meant to be limiting. Rather, it should be understood that by training the sign language NLP model in the manner described herein, the sign language NLP model is also capable of processing two-handed sign language video content.

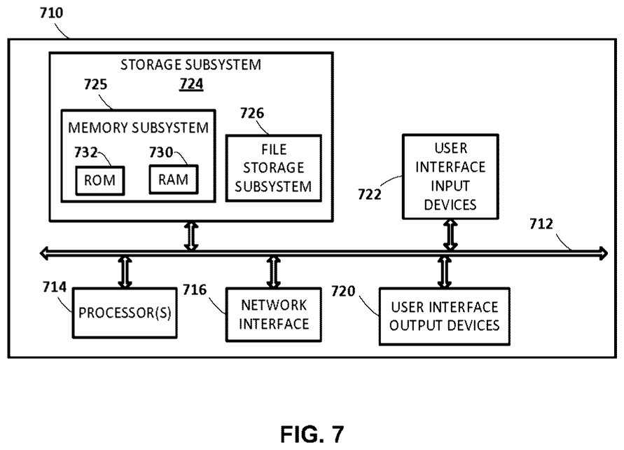

Turning now to FIG. 3, a flowchart illustrating an example method 300 of generating training instances for training a sign language NLP model and training the sign language NLP is depicted. For convenience, the operations of the method 300 are described with reference to a system that performs the operations. This system of the method 300 includes at least one processor, memory, and/or other component(s) of computing device(s) (e.g., client device 110 of FIGS. 1, 5A, 5B, 5C, and 6, sign language NLP system 120 of FIG. 1, computing device 710 of FIG. 7, and/or other computing devices). Moreover, while operations of the method 300 are shown in a particular order, this is not meant to be limiting. One or more operations may be reordered, omitted, and/or added.

At block 352, the system obtains sign language video content, the sign language video content capturing a user performing one or more two-handed sign language signs with two hands of the user. The sign language video content can be obtained, for example, from a repository of sign language video content that is accessible by a plurality of users (e.g., YouTube-ASL or another repository of sign language video content) and as described herein (e.g., with respect to the content sampling engine 130 of FIGS. 1 and 2). In some implementations, the sign language video content can be stored in association with captions or a timed caption track that includes a natural language interpretation of the one or more two-handed sign language signs captured in the sign language video content. In these implementations, the system can also obtain the captions or the caption track. In additional or alternative implementations, the sign language video content may not be stored in association with captions or a timed caption track. In these implementations, the system can utilize a previously trained sign language captioning model to generate the captions or the timed caption track.

At block 354, the system generates, based on the sign language video content, augmented sign language video content, the augmented sign language video content masking out at least a given hand, of the two hands of the user, while the user is performing the one or more two-handed sign language signs resulting in one or more corresponding one-handed sign language signs. For example, and as indicated at sub-block 354A, the system can detect a dominant hand of the user in generating the augmented sign language video content (e.g., as described with respect to the detection engine 151 and the masking engine 152 of FIGS. 1 and 2). In these examples, the system can generate the augmented sign language video content by detecting and masking out at least the non-dominant hand of the user (and optionally other features of the user that are captured in the sign language video content) in the sign language video content or a lower-level representation of the sign language video content.

Additionally, or alternatively, and as indicated at sub-block 354B, the system can detect a right hand of the user in generating the augmented sign language video content (e.g., as described with respect to the detection engine 151 and the masking engine 152 of FIGS. 1 and 2). In these examples, the system can generate the augmented sign language video content by detecting and masking out at least the left hand of the user (and optionally other features of the user that are captured in the sign language video content) in the sign language video content or a lower-level representation of the sign language video content.

Additionally, or alternatively, and as indicated at sub-block 354C, the system can utilize a generative model in generating the augmented sign language video content (e.g., as described with respect to the detection engine 151 of FIGS. 1 and 2). In these examples, the system can directly generate the augmented sign language video content and based on processing the sign language video content or a lower-level representation of the sign language video content.

At block 356, the system determines whether to mirror the augmented sign language video content. The system can determine whether to mirror the augmented sign language video content based on a probability or probability distribution such that some instances of the augmented sign language video content are mirrored while other instances of the augmented sign language video content are not mirrored. For example, the system can determine to mirror every other instance of augmented sign language video content that is processed, one of every four instances of augmented sign language video content that is processed, or use any other technique that results in instances of augmented sign language video content that is not mirrored and instances of augmented sign language video content that is mirrored. If, at an iteration of block 356, the system determines not to mirror the augmented sign language video content, then the system proceeds to block 360. The operations of block 360 are described in more detail below.

If, at an iteration of block 356, the system determines to mirror the augmented sign language video content, then the system proceeds to block 358. At block 358, the system mirrors the augmented sign language video content. For example, in implementations where the augmented sign language video content includes a sequence of image frames, raw pixel values for the sequence of image frames, etc., the augmented sign language video content can be mirrored over a central y-axis of the sequence of image frames (e.g., as described with respect to the mirroring engine 153 of FIGS. 1 and 2). As another example, in implementations where the augmented sign language video content includes a lower-level representation of the sequence of image frames, the raw pixel values for the sequence of image frames, etc., the augmented sign language content can be mirrored around a landmark included in the lower-level representation (e.g., as described with respect to the mirroring engine 153 of FIGS. 1 and 2). Notably, in implementations where the augmented sign language content is mirrored, both the unmirrored augmented sign language content and the mirrored sign language content can be subsequently utilized in training the sign language NLP model.

At block 360, the system determines whether to obtain additional sign language video content. The system can determine whether to obtain additional sign language video content based on, for example, whether there is a sufficient quantity of training instances for training the sign language NLP model, whether there is additional sign language video content available, and/or based on other factors. If, at an iteration of block 360, the system determines to obtain additional sign language video content, then the system returns to block 352 and continues with an additional iteration of the operations of block 352-360. The additional iteration of the operations of block 352-360 can be performed in the same or similar manner described above, but with respect to processing of the additional sign language video content.

If at an iteration of block 360, the system determines not to obtain additional sign language video content, then the system proceeds to block 362. At block 362, the system trains a sign language NLP model. For example, the system can train the sign language NLP model using supervised learning techniques (e.g., as described with respect to the processing engine 161, the loss engine 162, and the update engine 163 of FIGS. 1 and 2).

At block 364, the system determines whether one or more conditions are satisfied for deploying the sign language NLP model. The one or more conditions can include, for example, determining whether the sign language NLP model has been trained based on a threshold quantity of augmented sign language video content, determining whether the sign language NLP model has been trained for a threshold duration of time, whether the sign language NLP model has achieved a threshold level of performance, and/or other conditions.

If, at an iteration of block 364, the system determines that the one or more conditions are not satisfied for deploying the sign language NLP model, then the system returns to block 362 to continue training the sign language NLP model. However, the system returning to block 362 is assuming that additional training instances are available. Accordingly, it should be understood that the system may additionally, or alternatively, return to block 352 if no additional training instances are available for further training the sign language NLP model.

If, at an iteration of block 364, the system determines that the one or more conditions are satisfied for deploying the sign language NLP model, then the system proceeds to block 366. At block 366, the system causes the sign language NLP model to be deployed. For example, the system can cause the sign language NLP model to be deployed in an offline manner and/or in an online manner (e.g., as described with respect to the offline inference engine 171 and the online inference engine 172 of FIG. 1, and as described with respect to FIGS. 4 and 6).

Turning now to FIG. 4, a flowchart illustrating an example method 400 of using a sign language natural language processing model is depicted. For convenience, the operations of the method 400 are described with reference to a system that performs the operations. This system of the method 400 includes at least one processor, memory, and/or other component(s) of computing device(s) (e.g., client device 110 of FIGS. 1, 5A, 5B, 5C, and 6, sign language NLP system 120 of FIG. 1, computing device 710 of FIG. 7, and/or other computing devices). Moreover, while operations of the method 400 are shown in a particular order, this is not meant to be limiting. One or more operations may be reordered, omitted, and/or added.

At block 452, the system receives vision data that captures a user performing one or more one-handed sign language signs with a hand of the user, the vision data being generated via vision component(s) of a client device of the user. For example, the system can receive the vision data that captures the user performing one or more one-handed sign language signs while the user is a holding a mobile device (e.g., a phone) with one hand to direct a field of view of the vision component(s) of the mobile device and performing the one or more one-handed sign language signs with the other hand. As another example, the system can receive the vision data that captures the user performing one or more one-handed sign language signs while the user is a driving a vehicle (e.g., a phone) with one hand one hand on the steering wheel of the vehicle and performing the one or more one-handed sign language signs within a field of a view of a vehicle computing device. As yet another example, the system can receive the vision data that captures the user performing one or more one-handed sign language signs while the user is a holding groceries, cooking, etc. with one hand while a field of view of the vision component(s) of a standalone speaker device (having at least the vision component(s)) and performing the one or more one-handed sign language signs with the other hand.

At block 454, the system processes, using a sign language NLP model, the vision data to generate predicted output. At block 456, the system determines, based on the predicted output, a predicted natural language interpretation of the one or more one-handed sign language signs captured in the vision data. In some implementations, the predicted output can include, for example, the predicted natural language interpretation of the one or more one-handed sign language signs. In other implementations, the predicted output can include, for example, a probability distribution over a sequence of tokens (e.g., words, word units, etc.), and the system can determine, based on the probability distribution over the sequence of tokens, the predicted natural language interpretation of the one or more one-handed sign language signs.

At block 458, the system causes, based on the predicted natural language interpretation of the one or more one-handed sign language signs captured in the vision data, one or more actions to be performed. It should be understood that the one or more actions to be performed can vary greatly based on the one or more one-handed sign language signs that are signed by the user. For example, the one or more actions can include actions to be performed by an automated assistant, actions to be performed by smart device(s), actions that are provided in furtherance of a dictation section, and/or other actions.

Although the method 400 of FIG. 4 is described with respect to being locally by the system (e.g., locally at the client device of the user), it should be understood that is for the sake of example and is not meant to be limiting. For example, the vision data that captures the user performing the one or more one-handed sign language signs can be transmitted from the client device and to a remote system (e.g., over the one or more networks 199 of FIG. 1) that executes the sign language NLP model. In this example, the remote system can process the vision data and transmit an indication of the one or more actions to be performed back to the client device and/or cause the one or more actions to be performed (e.g., by sending commands directly to smart devices, software applications, etc.).

Further, although the method 400 of FIG. 4 is described with respect to the sign language NLP model being utilized in an online manner (e.g., in response to receiving the vision data that captures the one or more one-handed sign language signs), it should be understood that is also for the sake of example and is not meant to be limiting. For example, the sign language NLP model can also be utilized in an offline manner (e.g., in response to detecting content that includes the one or more one-handed sign language signs). For instance, in response to detecting sign language video content being uploaded to a video repository, the sign language video content can be processed, using the sign language NLP model, to generate captions for the sign language video content.

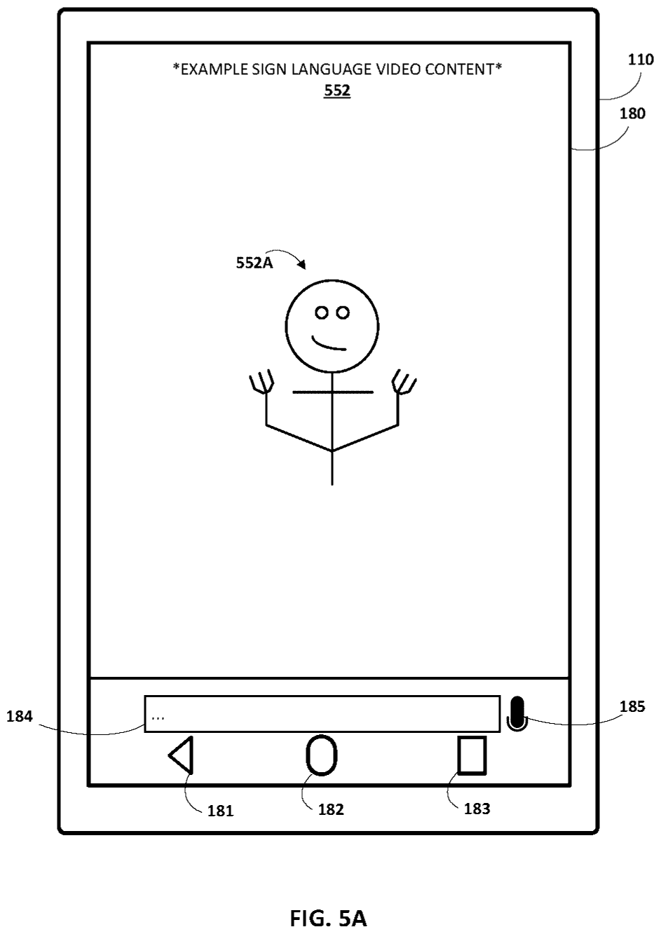

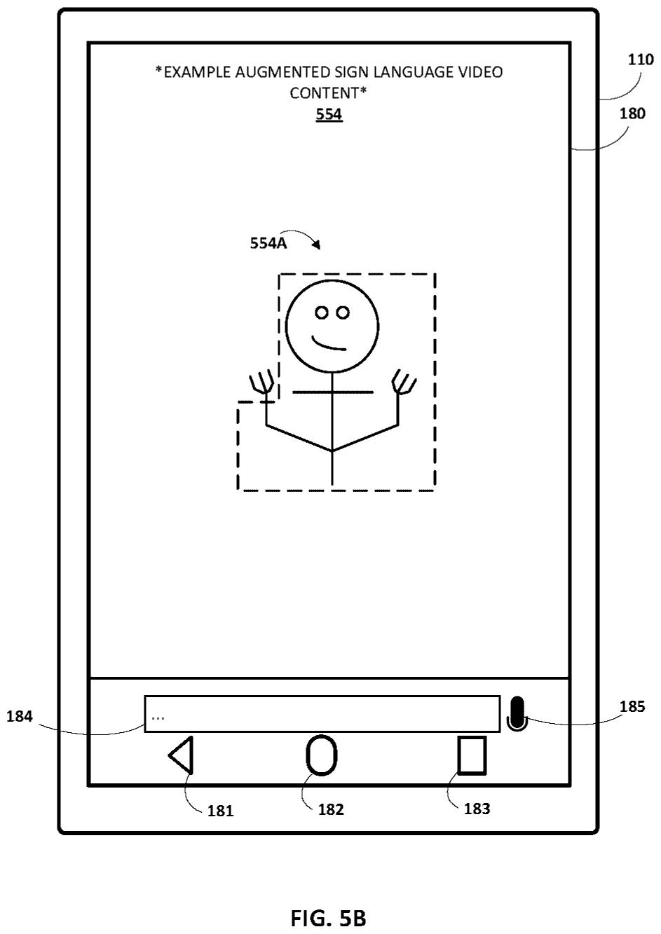

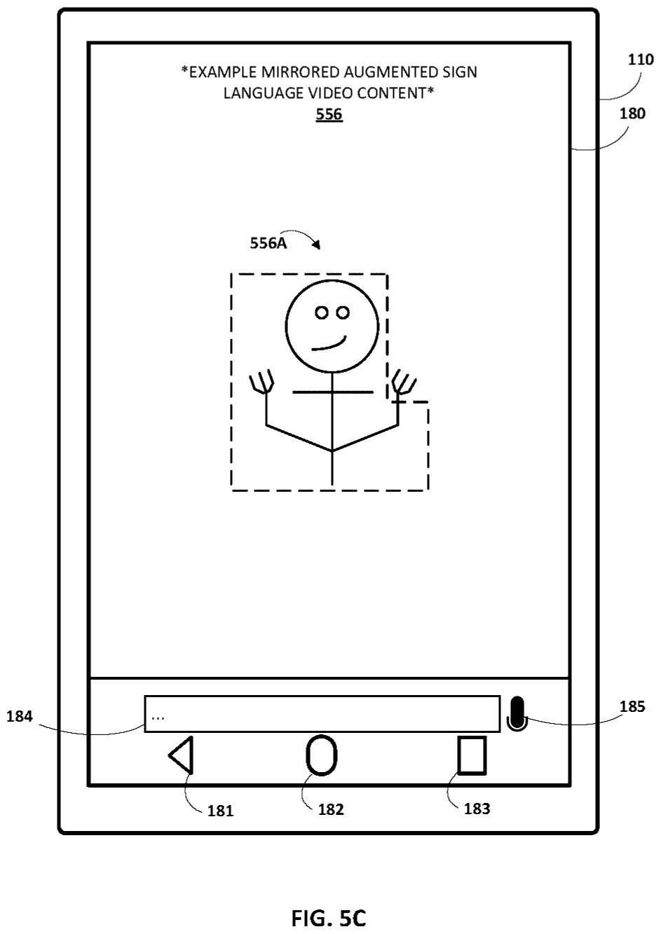

Turning now to FIGS. 5A, 5B, and 5C, various non-limiting examples of obtaining sign language video content and generating, based on the sign language video content, augmented sign language video content are depicted. FIGS. 5A, 5B, and 5C each depict a client device 110 (e.g., an instance of the client device 110 from FIG. 1) having a display 180. Although the client device 110 of FIGS. 5A, 5B, and 5C is depicted as a mobile phone, it should be understood that is not meant to be limiting. The client device 110 can be, for example, a stand-alone assistant device (e.g., with speaker(s) and/or a display), a laptop, a desktop computer, a wearable computing device (e.g., a smart watch, smart headphones, etc.), a vehicular computing device, and/or any other client device capable of making telephonic calls.

The display 180 of the client device 110 in FIGS. 5A, 5B, and 5C further includes a textual input interface element 184 that the user may select to generate user input via a keyboard (virtual or real) or other touch and/or typed input, and a spoken input interface element 185 that the user may select to generate user input via microphone(s) of the client device 110. In some implementations, the user may generate user input via the microphone(s) without selection of the spoken input interface element 185. For example, active monitoring for audible user input via the microphone(s) may occur to obviate the need for the user to select the spoken input interface element 185. In some of those and/or in other implementations, the spoken input interface element 185 may be omitted. Moreover, in some implementations, the textual input interface element 184 may additionally and/or alternatively be omitted (e.g., the user may only provide audible user input). The display 180 of the client device 110 in FIGS. 5A, 5B, and 5C also includes system interface elements 181, 182, 183 that may be interacted with by the user to cause the client device 110 to perform one or more actions.

Referring specifically to FIG. 5A, for the sake of example, assume that example sign language video content 552 is obtained that includes a user performing one or more two-handed sign language signs 552A. In the example of FIG. 5A, the sign language video content 552 include a lower-level representation of a sequence of image frames, raw pixel values for the sequence of image frames, etc. (e.g., a skeletonized representation of the user generated using MediaPipe Holistic or another computer vision tool). For instance, the shoulders of the user are represented by a line, the hands of the user have joints, there are landmarks on the face of the user that represent the eyes and mouth of the user, etc. However, it should be understood that the sign language video content 552 can alternatively include the sequence of image frames, the raw pixel values for the sequence of image frames, etc. instead of the lower-level representation thereof.

Referring specifically to FIG. 5B, assume that a system (e.g., the NLP system 120 of FIGS. 1 and 2 or the system of the method 300 of FIG. 3) detects that the right hand of the user is the user's dominant hand or simply assumes that the right hand of the user is the user's dominant hand. In this example, the system can generate an example augmented sign language video content 554 that masks at least the left hand of the user and, optionally, other features of the user (e.g., the user's face, the user's shoulders, the user's elbows, etc.). The mask that is applied to generate the example augmented sign language video content 554 is depicted in FIG. 5B as a bounding box, but it should be understood that is for the sake of example and is not meant to be limiting. Accordingly, even though the example sign language video content 552 obtained in FIG. 5A includes the user performing one or more two-handed sign language signs 552A, the example augmented sign language video content 554 generated in FIG. 5B results in one or more one-handed sign language signs 554A. The example augmented sign language video content 554 can be subsequently utilized as part of a training instance for training a sign language NLP model (e.g., as described with respect to FIGS. 2 and 3).

Referring specifically to FIG. 5C, assume that the system additionally, or alternatively, determines to mirror the example sign language video content 552 or the example augmented sign language video content 554, thereby generating example mirrored augmented sign language video content 556 that results in one or more one-handed sign language signs 556A that are mirrored along a y-axis relative to the one or more one-handed sign language signs 554A in the example augmented sign language video content 554 of FIG. 5B. Similar to the mask that is applied in FIG. 5B, the mask that is applied in FIG. 5C to generate the example mirrored augmented sign language video content 556 is depicted in FIG. 5C as a bounding box, but it should be understood that is for the sake of example and is not meant to be limiting. Accordingly, even though the example sign language video content 552 obtained in FIG. 5A includes the user performing one or more two-handed sign language signs 552A, the example mirrored augmented sign language video content 556 generated in FIG. 5C results in the one or more one-handed sign language signs 556A. The example mirrored augmented sign language video content 556 can be subsequently utilized as part of a training instance for training a sign language NLP model (e.g., as described with respect to FIGS. 2 and 3).

In the example of FIG. 5C, although the example mirrored augmented sign language video content 556 is depicted as being mirrored along a y-axis relative to the one or more one-handed sign language signs 554A in the example augmented sign language video content 554 of FIG. 5B, it should be understood that is for the sake of example and to illustrate some techniques contemplated herein. Rather, it should be understood that the example mirrored augmented sign language video content 556 can be mirrored along, for example, landmarks of the non-masked hand of the user that is being utilized to perform the one or more one-handed sign language signs 554A in the example augmented sign language video content 554 of FIG. 5B. Further, it should be understood that the example mirrored augmented sign language video content 556 can be generated based on the example sign language video content 552 of FIG. 5A and then subsequently masked as described herein. Moreover, it should be understood that a portion of the example mirrored augmented sign language video content 556 encompassed by the bounding box could be cropped out, such that the example mirrored augmented sign language video content 556 may only include the unmasked hand of the user.

Furthermore, it should be understood that in other implementations, the system can utilize a generative model to process the example sign language video content 552 of FIG. 5A to generate the example augmented sign language video content 554 of FIG. 5B and/or to generate the example mirrored augmented sign language video content 556 of FIG. 5C without explicit detection and/or masking operations or steps (e.g., as described with respect to FIGS. 2 and 3).

Turning now to FIG. 6, a non-limiting example of utilizing a trained sign language natural language processing model is depicted. FIG. 6 depicts the client device 110 having the display 180 from FIGS. 5A and 5B along with the same interface elements 181, 182, 183, 184, and 185. Similar to FIGS. 5A, 5B, and 5C, although the client device 110 of FIG. 6 is depicted as a mobile phone, it should be understood that is not meant to be limiting.

For the sake of example, assume that a user of the client device 110 is interacting with an example automated assistant application. In interacting with the example automated assistant application, assume that the user is holding the client device 110 with their left hand and directing a field of view of vision component(s) of the client device 110 towards their right hand to capture live sign language video content 652. The live sign language video content 652 can include the user's right hand performing one or more one-handed sign language signs 652A. In the example of FIG. 6, a system (e.g., the NLP system 120 of FIGS. 1 and 2 or the system of the method 300 of FIG. 3) can process, using a sign language NLP model (e.g., trained as described with respect to FIGS. 2 and 3), the live sign language video content 652 to generate a predicted natural language interpretation of the one or more one-handed sign language signs 652A. Further, the system can cause one or more actions to be performed based on the predicted natural language interpretation of the one or more one-handed sign language signs 652A.

For instance, the predicted natural language interpretation of the one or more one-handed sign language signs 652A can be provided as part of a dictation session with the automated assistant where the predicted natural language interpretation of the one or more one-handed sign language signs 652A is incorporated into a transcription (e.g., of a text message, an email message, etc.); the predicted natural language interpretation of the one or more one-handed sign language signs 652A can be provided to control one or more smart devices (e.g., turn on/off lights, turn up/down a thermostat, turn on/off a smart oven, open/close a garage, etc.); the predicted natural language interpretation of the one or more one-handed sign language signs 652A can be provided to control one or more software applications accessible at the client device 110 (e.g., to stream media content, to complete a transaction, etc.); and/or provided to cause any other action(s) that can be performed by the client device 110 and/or an automated assistant executing at least in part at the client device 110.

Turning now to FIG. 7, a block diagram of an example computing device 710 that may optionally be utilized to perform one or more aspects of techniques described herein. In some implementations, one or more of a client device, remote system component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIGS. 1 and 2.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: obtaining sign language video content, the sign language video content capturing a user performing one or more two-handed sign language signs with two hands of the user; generating, based on the sign language video content, augmented sign language video content, the augmented sign language video content masking out at least a given hand of the user, of the two hands of the user, while the user is performing the one or more two-handed sign language signs resulting in one or more corresponding one-handed sign language signs; training, based on the augmented sign language video content, a sign language natural language processing model; and subsequent to training the sign language natural language processing model: causing the sign language natural language processing model to be deployed.

These and other implementations of technology disclosed herein can optionally include one or more of the following features.

In some implementations, generating the augmented sign language video content based on the sign language video content may include: determining, from among the two hands of the user, a dominant hand of the user and a non-dominant hand of the user; and masking out at least the non-dominant hand of the user, as the given hand of the user, while the user is performing the one or more two-handed sign language signs to generate the augmented sign language video content that includes the one or more corresponding one-handed sign language signs.

In some implementations, generating the augmented sign language video content based on the sign language video content may include: determining, from among the two hands of the user, a right hand of the user and a left hand of the user; and masking out at least the left hand of the user, as the given hand of the user, while the user is performing the one or more two-handed sign language signs to generate the augmented sign language video content that includes the one or more corresponding one-handed sign language signs.

In some versions of those implementations, the method may further include: generating, based on the augmented sign language video content, additional augmented sign language video content. Generating the additional augmented sign language video content based on the augmented sign language video content may include: mirroring the augmented sign language video content such that the right hand of the user appears as the left hand of the user to generate the additional augmented sign language video content; and training, based on the additional augmented sign language video content and based on an indication that the additional augmented sign language video is a flipped version of the augmented sign language video content, the sign language natural language processing model.

In some implementations, generating the augmented sign language video content based on the sign language video content may include: determining, from among the two hands of the user, a right hand of the user and a left hand of the user; and masking out at least the right hand of the user, as the given hand of the user, while the user is performing the one or more two-handed sign language signs to generate the augmented sign language video content that includes the one or more corresponding one-handed sign language signs.

In some versions of those implementations, the method may further include generating, based on the augmented sign language video content, additional augmented sign language video content. Generating the additional augmented sign language video content based on the augmented sign language video content may include: mirroring the augmented sign language video content such that the left hand of the user appears as the right hand of the user to generate the additional augmented sign language video content; and training, based on the additional augmented sign language video content and based on an indication that the additional augmented sign language video is a flipped version of the augmented sign language video content, the sign language natural language processing model.

In some implementations, the method may further include, prior to generating the augmented sign language video content based on the sign language video content: processing the sign language video content to generate a skeletonized representation of the sign language video content, the augmented sign language video content including a portion of the skeletonized representation of the sign language video content and for the one or more corresponding one-handed sign language signs.

In some implementations, the sign language video content may be a skeletonized representation of the one or more sign language signs, and the augmented sign language video content may include a portion of the skeletonized representation of the sign language video content for the one or more corresponding one-handed sign language signs.

In some implementations, the method may further include: obtaining a sign language caption track for the sign language video content, the sign language caption track video including a ground truth natural language interpretation of the one or more two-handed sign language signs captured in the sign language video content.

In some versions of those implementations, training the sign language natural language processing model based on the augmented sign language video content may include: processing, using the sign language natural language processing model, the augmented sign language video content to generate predicted output; determining, based on the predicted output, a predicted natural language interpretation of the one or more corresponding one-handed sign language signs captured in the augmented sign language video content; generating, based on comparing the predicted natural language interpretation of the one or more corresponding one-handed sign language signs captured in the augmented sign language video content and the ground truth natural language interpretation of the one or more two-handed sign language signs captured in the sign language video content, one or more losses; and updating, based on the one or more losses, the sign language natural language processing model.

In some implementations, the method may further include, prior to training the sign language natural language processing model: processing, using a sign language captioning model, the sign language video content to determine a ground truth natural language interpretation of the one or more two-handed sign language signs captured in the sign language video content.

In some versions of those implementations, training the sign language natural language processing model based on the augmented sign language video content may include: processing, using the sign language natural language processing model, the augmented sign language video content to generate predicted output; determining, based on the predicted output, a predicted natural language interpretation of the one or more corresponding one-handed sign language signs captured in the augmented sign language video content; generating, based on comparing the predicted natural language interpretation of the one or more corresponding one-handed sign language signs captured in the augmented sign language video content and the ground truth natural language interpretation of the one or more two-handed sign language signs captured in the sign language video content, one or more losses; and updating, based on the one or more losses, the sign language natural language processing model.

In some implementations, causing the sign language natural language processing model to be deployed may be further in response to determining one or more training conditions are satisfied.

In some versions of those implementations, the one or more training conditions may include one or more of: determining whether the sign language natural language processing model has been trained based on a threshold quantity of augmented sign language video content, determining whether the sign language natural language processing model has been trained for a threshold duration of time, or whether the sign language natural language processing model has achieved a threshold level of performance.

In some implementations, causing the sign language natural language processing model to be deployed may include: causing a corresponding instance of the sign language natural language processing model to be transmitted to a plurality of client devices for utilization locally at the plurality of client devices and in processing vision data that captures one-handed sign language.

In some implementations, causing the sign language natural language processing model to be deployed may include: causing the sign language natural language processing model to process corresponding vision data that captures one-handed sign language and that is received from a plurality of client devices or that is detected at a remote server.

In some implementations, generating the augmented sign language video content based on the sign language video content may include: processing, using a generative model, the sign language video content to generate the augmented sign language video content.

In some versions of those implementations, processing the sign language video content to generate the augmented sign language video content using the vision data-to-vision data foundation model further may include: processing, using the generative model, and along with the sign language video content, a prompt that includes instructions for generating the augmented sign language video content.

In additional or alternative versions of those implementations, the method may further include, prior to processing the sign language video content to generate the augmented sign language video content: training the generative model to process the sign language video content to generate the augmented sign language video content. Training the generative model to process the sign language video content to generate the augmented sign language video content may include: obtaining a training instance pair that includes the one or more two-handed sign language signs and the one or more corresponding one-handed sign language signs; processing, using the generative model, the one or more two-handed sign language signs to generate one or more corresponding predicted one-handed sign language signs; generating, based on comparing the one or more corresponding predicted one-handed sign language signs and the one or more corresponding one-handed sign language signs, one or more losses; and updating, based on the one or more losses, the generative model.

In some implementations, the sign language video content may be obtained from a sign language video content repository.

In some implementations, a method implemented by one or more processors is provided, and includes: receiving vision data that captures a user performing one or more one-handed sign language signs with one hand of the user, the vision data being generated via one or more vision components a client device of the user; processing, using a sign language natural language processing model, the vision data to generate predicted output; determining, based on the predicted output, a predicted natural language interpretation of the one or more one-handed sign language signs captured in the vision data; and causing, based on the predicted natural language interpretation of the one or more one-handed sign language signs captured in the vision data, one or more actions to be performed.

These and other implementations of technology disclosed herein can optionally include one or more of the following features.

In some implementations, the client device may be a mobile device of the user, and the user may be holding the mobile device with the other hand of the user such that the hand of the user is in a field of view of the one or more vision components.

In some implementations, the client device may be a vehicle computing device of a vehicle of the user, and the other hand of the user may be being utilized in controlling the vehicle of the user.

In some implementations, the method may further include, prior to processing the vision data to generate the predicted output using the sign language natural language processing model: training the sign language natural language processing model.

In some versions of those implementations, training the sign language natural language processing model may include: obtaining sign language video content, the sign language video content capturing the user or an additional user performing one or more two-handed sign language signs; generating, based on the sign language video content, augmented sign language video content, the augmented sign language video content masking out at least a given hand of the user, of the user or the additional user, while the user or the additional user is performing the one or more two-handed sign language signs resulting in one or more corresponding one-handed sign language signs; and training, based on the augmented sign language video content, a sign language natural language processing model.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
obtaining sign language video content, the sign language video content capturing a user performing one or more two-handed sign language signs with two hands of the user;
generating, based on the sign language video content, augmented sign language video content, the augmented sign language video content masking out at least a given hand of the user, of the two hands of the user, while the user is performing the one or more two-handed sign language signs resulting in one or more corresponding one-handed sign language signs;
training, based on the augmented sign language video content, a sign language natural language processing model; and
subsequent to training the sign language natural language processing model:
causing the sign language natural language processing model to be deployed.

2. The method of claim 1, wherein generating the augmented sign language video content based on the sign language video content comprises:
determining, from among the two hands of the user, a dominant hand of the user and a non-dominant hand of the user; and
masking out at least the non-dominant hand of the user, as the given hand of the user, while the user is performing the one or more two-handed sign language signs to generate the augmented sign language video content that includes the one or more corresponding one-handed sign language signs.

3. The method of claim 1, wherein generating the augmented sign language video content based on the sign language video content comprises:
determining, from among the two hands of the user, a right hand of the user and a left hand of the user; and
masking out at least the left hand of the user, as the given hand of the user, while the user is performing the one or more two-handed sign language signs to generate the augmented sign language video content that includes the one or more corresponding one-handed sign language signs.

4. The method of claim 3, further comprising:
generating, based on the augmented sign language video content, additional augmented sign language video content, wherein generating the additional augmented sign language video content based on the augmented sign language video content comprises:
mirroring the augmented sign language video content such that the right hand of the user appears as the left hand of the user to generate the additional augmented sign language video content; and
training, based on the additional augmented sign language video content and based on an indication that the additional augmented sign language video is a flipped version of the augmented sign language video content, the sign language natural language processing model.

5. The method of claim 1, wherein generating the augmented sign language video content based on the sign language video content comprises:
determining, from among the two hands of the user, a right hand of the user and a left hand of the user; and
masking out at least the right hand of the user, as the given hand of the user, while the user is performing the one or more two-handed sign language signs to generate the augmented sign language video content that includes the one or more corresponding one-handed sign language signs.

6. The method of claim 5, further comprising:
generating, based on the augmented sign language video content, additional augmented sign language video content, wherein generating the additional augmented sign language video content based on the augmented sign language video content comprises:
mirroring the augmented sign language video content such that the left hand of the user appears as the right hand of the user to generate the additional augmented sign language video content; and
training, based on the additional augmented sign language video content and based on an indication that the additional augmented sign language video is a flipped version of the augmented sign language video content, the sign language natural language processing model.

7. The method of claim 1, further comprising:
prior to generating the augmented sign language video content based on the sign language video content:
processing the sign language video content to generate a skeletonized representation of the sign language video content, the augmented sign language video content including a portion of the skeletonized representation of the sign language video content and for the one or more corresponding one-handed sign language signs.

8. The method of claim 1, wherein the sign language video content is a skeletonized representation of the one or more sign language signs, and wherein the augmented sign language video content including a portion of the skeletonized representation of the sign language video content for the one or more corresponding one-handed sign language signs.

9. The method of claim 1, further comprising:
obtaining a sign language caption track for the sign language video content, the sign language caption track video including a ground truth natural language interpretation of the one or more two-handed sign language signs captured in the sign language video content.

10. The method of claim 9, wherein training the sign language natural language processing model based on the augmented sign language video content comprises:
processing, using the sign language natural language processing model, the augmented sign language video content to generate predicted output;
determining, based on the predicted output, a predicted natural language interpretation of the one or more corresponding one-handed sign language signs captured in the augmented sign language video content;
generating, based on comparing the predicted natural language interpretation of the one or more corresponding one-handed sign language signs captured in the augmented sign language video content and the ground truth natural language interpretation of the one or more two-handed sign language signs captured in the sign language video content, one or more losses; and
updating, based on the one or more losses, the sign language natural language processing model.

11. The method of claim 1, further comprising:
prior to training the sign language natural language processing model:
processing, using a sign language captioning model, the sign language video content to determine a ground truth natural language interpretation of the one or more two-handed sign language signs captured in the sign language video content.

12. The method of claim 11, wherein training the sign language natural language processing model based on the augmented sign language video content comprises:
processing, using the sign language natural language processing model, the augmented sign language video content to generate predicted output;
determining, based on the predicted output, a predicted natural language interpretation of the one or more corresponding one-handed sign language signs captured in the augmented sign language video content;
generating, based on comparing the predicted natural language interpretation of the one or more corresponding one-handed sign language signs captured in the augmented sign language video content and the ground truth natural language interpretation of the one or more two-handed sign language signs captured in the sign language video content, one or more losses; and
updating, based on the one or more losses, the sign language natural language processing model.

13. The method of claim 1, wherein causing the sign language natural language processing model to be deployed is further in response to determining one or more training conditions are satisfied.

14. The method of claim 13, wherein the one or more training conditions comprise one or more of: determining whether the sign language natural language processing model has been trained based on a threshold quantity of augmented sign language video content, determining whether the sign language natural language processing model has been trained for a threshold duration of time, or whether the sign language natural language processing model has achieved a threshold level of performance.

15. The method of claim 1, wherein causing the sign language natural language processing model to be deployed comprises:
causing a corresponding instance of the sign language natural language processing model to be transmitted to a plurality of client devices for utilization locally at the plurality of client devices and in processing vision data that captures one-handed sign language.

16. The method of claim 1, wherein causing the sign language natural language processing model to be deployed comprises:
causing the sign language natural language processing model to process corresponding vision data that captures one-handed sign language and that is received from a plurality of client devices or that is detected at a remote server.

17. The method of claim 1, wherein generating the augmented sign language video content based on the sign language video content comprises:
processing, using a generative model, the sign language video content to generate the augmented sign language video content.

18. The method of claim 17, wherein processing the sign language video content to generate the augmented sign language video content using the vision data-to-vision data foundation model further comprises:
processing, using the generative model, and along with the sign language video content, a prompt that includes instructions for generating the augmented sign language video content.

19. A system comprising:
at least one processor; and
memory storing instructions that, when executed by the at least one processor, cause the at least one processor to be operable to:
obtain sign language video content, the sign language video content capturing a user performing one or more two-handed sign language signs with two hands of the user;
generate, based on the sign language video content, augmented sign language video content, the augmented sign language video content masking out at least a given hand of the user, of the two hands of the user, while the user is performing the one or more two-handed sign language signs resulting in one or more corresponding one-handed sign language signs;
train, based on the augmented sign language video content, a sign language natural language processing model; and
subsequent to training the sign language natural language processing model:
cause the sign language natural language processing model to be deployed.

20. A non-transitory computer-readable storage medium storing instructions that, when executed by at least one processor, cause the at least one processor to be operable to perform operations, the operations comprising:
obtaining sign language video content, the sign language video content capturing a user performing one or more two-handed sign language signs with two hands of the user;
generating, based on the sign language video content, augmented sign language video content, the augmented sign language video content masking out at least a given hand of the user, of the two hands of the user, while the user is performing the one or more two-handed sign language signs resulting in one or more corresponding one-handed sign language signs;
training, based on the augmented sign language video content, a sign language natural language processing model; and
subsequent to training the sign language natural language processing model:
causing the sign language natural language processing model to be deployed.
